(19) United States
(12) Patent Application Publication
(10) Pub. No.: US 2021/0169623 A1
(43) Pub. Date: Jun. 10, 2021

(54) NON-PERMANENT LOW-TACK SELF-ADHESIVE PRESSURE-SENSITIVE GAUZE

(71) Applicant: Gioconda Valentina Bright, Murrysville, PA (US)

(72) Inventor: Gioconda Valentina Bright, Murrysville, PA (US)

(21) Appl. No.: 16/703,025

(22) Filed: Dec. 4, 2019

(51) Int. Cl. A61C 19/00

(52) U.S. Cl. CPC A61C 19/002

(57) ABSTRACT

The invention consists of a gauze provided with a structural non-permanent low-tack self-adhesive pressure-sensitive layer on one side, which facilitates the attachment of that side of the gauze to a surface, while the opposite side of the gauze is exposed and available for operator to use. The low-tack self-adhesive pressure-sensitive layer allows the non-permanent low-tack self-adhesive pressure-sensitive gauze to be easily attached to a surface and, after use, to be easily removed in one motion, without altering the surface on which it is temporarily attached.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of Invention

The present invention relates to gauze, and more particularly, to expanding and improving the methods of using it, by attaching to it a non-permanent low-tack self-adhesive pressure-sensitive structural layer.

### 2. Description of the Prior Art

The use of gauze is known in the prior art. Gauze, by definition, is generally a bleached cotton cloth of plain open weave and differing degrees of fineness, used for dressings, bandages, surgical sponges or non-adherent protective covering for wounds.

Known prior art includes inventions under which the gauze is used to fulfill the objectives and functions described in its definition. There is a great number of patents granted to a wide variety of bandages, dressings, cleaning and surgical sponges, all focused on improving the healing process and expanding the range of conditions to be addressed, and most of which address the needs of the end user, the person in need to isolate and treat a condition or a wound.

The present invention departs from the uses of the gauze described in its definition and the conventional concepts and designs of the prior art, and ads a new concept of making the piece of gauze itself a stable, secure work surface by adding a non-permanent low-tack self-adhesive pressure-sensitive structural layer.

The present invention is focused on the needs of the operator, for whom the gauze is part of the armamentarium used in the process of care delivery. Gauze alone is light weight, loosely woven, does not have stability, it easily falls or is caught in instruments, garments, narrow places, and so on. The present invention is meant to address these inconveniences, by providing the possibility to secure the gauze to a surface convenient to the operator, be available for use by the operator, and to be easily removed after use.

The non-permanent low-tack self-adhesive pressure-sensitive gauze provides a low-tack self-adhesive pressure-sensitive structural layer, which other patents do not.

U.S. Design Pat. No. D783842 teaches an ornamental design for a gauze bandage. The patent does not teach a gauze provided with a non-permanent low-tack self-adhesive pressure-sensitive structural layer with one side adherent to other surfaces than the skin, while on the opposite side of the non-permanent low-tack self-adhesive pressure-sensitive structural layer one side of the gauze is entirely attached, while the opposite side of the gauze is entirely exposed.

### BRIEF SUMMARY OF THE INVENTION

The current conventional uses of gauze are described in its definition: dressings, bandages, surgical sponges or non-adherent protective covering for wounds. Bandages and dressings are basically pieces of gauze, plain or soaked in dressings or antiseptics, attached to an adhesive strip which positions the gauze on a designated area, and secures, seals and isolates the designated area and the gauze from the exterior environment. Gauzes are also used loose, for cleaning wounds, debris on the skin and other miscellaneous purposes.

The invention departs from the conventional uses of gauze described above, introduces a new concept, new functions and features. The invention produced a modified non-permanent low-tack self-adhesive pressure-sensitive gauze and develops a new method of using the gauze, which is not anticipated, rendered obvious, suggested or implied by any prior art, either alone or in combination.

The invention stems from my experience as a registered dental hygienist. During dental procedures, gauze is used by operators, among other tasks, to constantly clean the debris or materials accumulated on dental instruments. Keeping the tips of the instruments clean is critical for precision, patient safety, for preventing contamination and for the success of the procedure. Most commonly, the gauze is placed loosely on a tray that holds the armamentarium and materials used by the operator during the procedure (commonly referred to as instruments' tray), or on the patient's napkin. In both cases, it is outside of the immediate work area.

Having the gauze on the instruments' tray, implies that, in order to clean debris from the work instrument, the operator stops the procedure, sets down the instrument in the non-dominant hand in order to reach for the gauze, cleans the work instrument held in the dominant hand with the gauze, places the gauze back on the instruments' tray after use, picks up the instrument held initially in the non-dominant hand, repositions both hands and instruments in the work area, and continues the procedure. This is time consuming, disrupting, requires readjusting and repositioning of the operator and the instruments.

Having the gauze placed loosely on the patient's napkin that covers the patient's chest area during the dental procedure, may be inconvenient for both, the patient and the operator. By single-handedly wiping off the instrument on the gauze placed loosely on the patient's napkin, dental instruments, most of them sharp and pointy, could penetrate through the patient napkin and garments and scratch or puncture patient's skin. By single-handedly wiping the instrument on the gauze placed loosely on the patient's napkin, the gauze can be caught in the sharp tip of the instrument (which means another interruption to untangle the gauze, or to replace it with a new piece of gauze), or can fall outside the work area or on the floor, causing risk of contamination.

Both options involve interruptions, an added number of motions, the need to reach outside the immediate work area, all undesirable and avoidable.

The objectives of this invention are:
to introduce an economy of motions by eliminating the need to reach outside the immediate work area and minimizing the need to readjust and reposition operator and instruments
to increase efficiency (a limited, more controlled set of motions is less time consuming)
to increase stability of work equipment and operator (the gauze being in a fixed position can't fall or get caught in instruments' tips, there is reduced or no need for readjustments)
to increase patient safety
to decrease waste
to reduce chances of contamination
to reduce aggravation.

The invention provides a modified gauze, which includes a structural self-adhesive layer. The non-permanent low-tack pressure-sensitive adhesive layer permits easy attachment and removal of the gauze to a surface. When in use, the gauze is facing away from the surface on which it is attached via the non-permanent low-tack pressure-sensitive adhesive layer, being exposed and available to the operator.

The following sections offer a detailed description of the invention, drawings illustrating the construction of the invention, a suggested use and a suggested delivery system. The drawings depicting a suggested use and a suggested delivery system are introduced to help understand the concept and the methods of using and delivering the invention, and not intended to be limiting, as the only ways to use and deliver the invention.

The invention is not limited in its application to the above described health care environment, could find a broader range of applications in any other field or environment if deemed safe and appropriate. The invention is capable of different embodiments, various shapes, arrangements, and delivery systems.

The invention could be easily and inexpensively manufactured and marketed.

### BRIEF DESCRIPTION OF THE DRAWINGS

FIG. 1 is a top plan view of the non-permanent low-tack self-adhesive pressure-sensitive gauze in accordance with the invention.

FIG. 2 is a cross sectional view of the non-permanent low-tack self-adhesive pressure-sensitive gauze in accordance with the invention.

FIG. 3 is a bottom plan view of the non-permanent low-tack self-adhesive pressure-sensitive gauze in accordance with the invention.

FIG. 4 is a perspective view of the non-permanent low-tack self-adhesive pressure-sensitive gauze in accordance with the invention.

FIG. 5 is a perspective view of joined pieces of non-permanent low-tack self-adhesive pressure-sensitive gauze delivered in the form of a roll dispenser.

FIG. 6 is a schematic functional view of a non-permanent low-tack self-adhesive pressure-sensitive gauze in a potential position of use (on a gloved hand).

### DETAILED DESCRIPTION OF THE INVENTION

In FIG. 1 through FIG. 6, reference numbers denote the components of the invention, as follows:
10=gauze
20=anchoring frame
30=non-permanent low-tack self-adhesive pressure-sensitive structural layer
40=peel-off layer
50=perforation
60=roll dispenser
70=gloved hand

FIG. 1 through FIG. 4 illustrate the concept, the principles, and the embodiment of the invented non-permanent low-tack self-adhesive pressure-sensitive gauze.

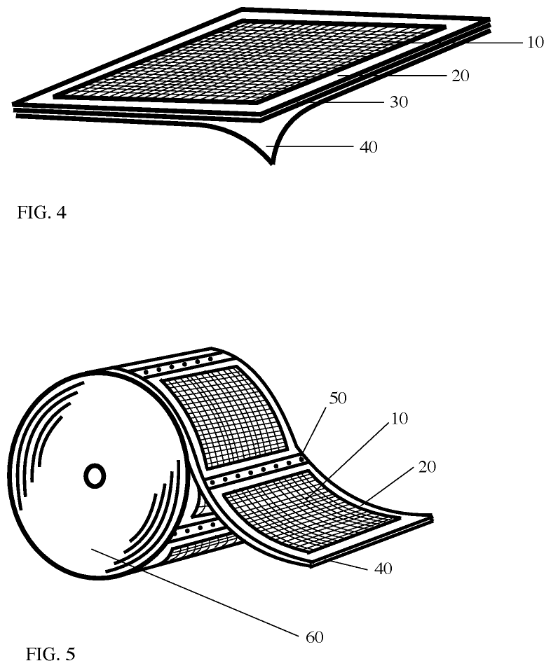

FIG. 4 shows a perspective view of the invention, which comprises a piece of gauze 10, an anchoring frame 20, a non-permanent low-tack self-adhesive pressure-sensitive structural layer 30, and a peel-off layer 40.

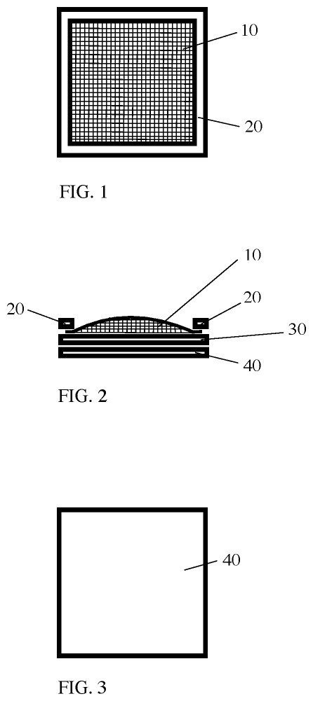

The gauze 10 is centered on the non-permanent low-tack self-adhesive pressure-sensitive structural layer 30, on which it is anchored by the frame 20, as visible in FIG. 1 and FIG. 2.

As illustrated in the cross sectional view in FIG. 2, the non-permanent low-tack self-adhesive pressure-sensitive structural layer 30 is slightly but reasonably larger than the gauze 10. The outside dimensions of the anchoring frame 20 are identical with the dimensions of the non-permanent low-tack self-adhesive pressure-sensitive structural layer 30, as illustrated in FIG. 1 and FIG. 2. The inside dimensions of the anchoring frame 20 are slightly but reasonably smaller than the outside dimensions of the gauze 10, also visible in FIG. 2. The anchoring frame is adhesive on the downward surface that faces the gauze 10 and the non-permanent low-tack self-adhesive pressure-sensitive structural layer 30, and is positioned such way that it retains the gauze 10 centered on the non-permanent low-tack self-adhesive pressure-sensitive structural layer 30 by adhering to both. The inside and outside dimensions of the anchoring frame 20 and dimensions of non-permanent low-tack self-adhesive pressure-sensitive structural layer 30 are not restrictive, and they can be determined during the manufacturing process, according to the materials, supplies and machinery at hand. However, the outside dimensions of the anchoring frame 20 and the outside dimensions of the non-permanent low-tack self-adhesive pressure-sensitive structural layer 30, as well as the dimensions of the peel-off layer 40, must be identical and reasonably larger than the outside dimensions of the gauze 10, as shown in FIG. 1, FIG. 2, FIG. 3 and FIG. 4. As an alternative to the anchoring frame 20, if the existing materials and the manufacturing processes permit, the gauze can be directly and permanently glued to the non-permanent low-tack self-adhesive pressure-sensitive structural layer 30. In this case, the anchoring frame 20 is optional, or the outside dimensions of the anchoring frame 20 and dimensions of non-permanent low-tack self-adhesive pressure-sensitive structural layer 30 may or may not be identical. This alternative is to be considered only if the materials and the manufacturing processes do not alter the consistency, flexibility and absorbent properties of the gauze 10.

The non-permanent low-tack self-adhesive pressure-sensitive side of the non-permanent low-tack self-adhesive pressure-sensitive structural layer 30 faces away from the gauze and is covered and preserved by a peel-off layer 40 until the moment of use, as shown in FIG. 4. When removed, the peel-off layer 40 exposes the non-permanent low-tack self-adhesive pressure-sensitive side of the non-permanent low-tack self-adhesive pressure-sensitive structural layer 30 (the opposite side of this layer faces and it is attached to the gauze), and the gauze modified according to the present invention is ready to be attached to the intended surface. The low-tack self-adhesive glue permits easy attachment and removal of the modified gauze in one single piece, in one single motion, without causing any damage to the surface on which it is attached.

The representation of the embodiment of the invention is based on the square shaped gauze 10, the most common common shape of gauze in the industry. The invention is designed for use in a non-sterile environment.

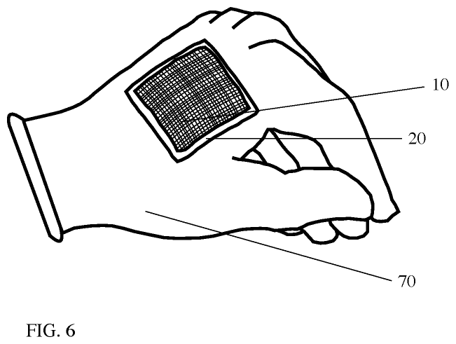

The invention could be dispensed individually wrapped or in bulk. Another suggested way to dispense the invention is a roll dispenser. In this case, each piece of the non-permanent low-tack self-adhesive pressure-sensitive gauze becomes a unit, a determined number of units being placed on a continuous strip and separated by perforations for quick and easy tearing. The units could be placed on the roll dispenser facing upward or downward. The ensemble of non-permanent low-tack self-adhesive pressure-sensitive 30 and its protective peel-off layer 40 could function as the continuous strip. FIG. 5 illustrates a suggested roll dispenser 60 on which the units face upward and are separated by perforations 50.

FIG. 6 illustrates a suggested use. By attaching a non-permanent low-tack self-adhesive pressure-sensitive gauze on the gloved hand 70, the gauze is easily available in the immediate work area.

The invention described in this patent may be embodied in other forms without departing from the essential characteristics thereof. The present embodiments are to be considered in all aspects illustrative and unrestrictive, the scope of the invention being indicated by the appended claims rather than by the foregoing description and all changes which come within the meaning and range of equivalency are, therefore intended to be embraced therein.

With respect to the above description, it is to be realized that the optimum dimensional relationship for the parts of the invention, to include variations in size, materials, shape, form, manner of operation, assembly and use, manner of packaging and delivery, are deemed readily apparent and obvious to one skilled in the art, and all equivalent relationships to those illustrated in the drawings and described in the specifications.

Therefore, the foregoing is considered as illustrative only of the principles of the invention. Since numerous modifications and changes will readily occur to those skilled in the art, it is not desired to limit the invention to the exact construction and operation shown and described, and, accordingly, all suitable modifications and equivalencies may be resorted to, falling within the scope of the invention.

The terms “gauze” and “gauze pad” are equivalent and interchangeable.

I claim:

1. A non-permanent low-tack self-adhesive pressure-sensitive gauze comprising:
a gauze pad centered and secured on a non-permanent low-tack self-adhesive pressure-sensitive structural layer, one side of the gauze pad being attached to the non-permanent low-tack self-adhesive pressure-sensitive structural layer and the opposite side of the gauze pad being exposed and available to the operator;
a non-permanent low-tack self-adhesive pressure-sensitive structural layer conforming to the shape of the gauze pad and slightly larger than the gauze pad permitting equal exposure of its margins while the gauze pad is centrally located on it, which has a non-permanent low-tack self-adhesive pressure-sensitive surface facing away from the gauze pad covered by the peel-off layer and has the function to attach the invention onto a surface after removing the peel-off layer, while the opposite surface of the non-permanent low-tack self-adhesive pressure-sensitive structural layer which is attached to the gauze pad, may or may not be adhesive;
an anchoring frame conforming to the shape of the gauze pad which secures the gauze pad centered onto the non-permanent low-tack self-adhesive pressure-sensitive structural layer, the inside dimension of the anchoring frame being smaller than the outside dimensions of the gauze pad and the outside dimensions of the anchoring frame being identical with the outside dimensions of the non-permanent low-tack self-adhesive pressure-sensitive structural layer, the anchoring frame including adhesive on the surface of the anchoring frame that overlaps and adheres to both, the perimeter of the gauze and the exposed margins of the non-permanent low-tack self-adhesive pressure-sensitive structural layer after the gauze pad is centered on it;
a peel-off layer of identical shape and size with the non-permanent low-tack self-adhesive pressure-sensitive structural layer, which has a low-tack adhesive surface which faces, adheres to, covers and preserves the entire self-adhesive surface of the non-permanent low-tack self-adhesive pressure-sensitive structural layer without altering the self-adhesive properties of the non-permanent low-tack self-adhesive pressure-sensitive structural layer and is easily removable in one motion to expose the adhesive side of the non-permanent low-tack self-adhesive pressure-sensitive structural layer, while the opposite surface of the peel-off layer is adhesive free, open to environment.
